(19) United States
(12) Patent Application Publication
(10) Pub. No.: US 2008/0318634 A1
(43) Pub. Date: Dec. 25, 2008

(54) WIRELESS COMMUNICATION APPARATUS AND METHOD FOR REPLACING BACKGROUND COLOR OF DISPLAY FOR SAME

(75) Inventors: Shih-Fang Wong, Tu-Cheng (TW); Tsung-Jen Chuang, Tu-Cheng (TW); Si-Yuan Yu, Shenzhen (CN); Jun-Fang Liu, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen)CO., LTD, Zhenzhen City (CN); HON HAI PRECISION INDUSTRY CO., LTD., Tu-Cheng (TW)

(21) Appl. No.: 11/941,973

(22) Filed: Nov. 19, 2007

(30) Foreign Application Priority Data
Jun. 22, 2007 (CN) 200710200865.2

(51) Int. Cl. H04M 1/00

(52) U.S. Cl. 455/566

(57) ABSTRACT

A wireless communication apparatus includes a communication module, a display, and a color control module. The communication module is for sending a message to a base station, and receiving a switch command from the base station. The display is for displaying an image. The color control module is for being enabled based on the switch command to replace a background color of the image. A method for replacing a background color of the wireless communication apparatus is also disclosed.

### BACKGROUND

1. Field of the Invention

The present invention generally relates to wireless communication apparatuses and methods, and more particularly to a wireless communication apparatus and a method for replacing background color of a display of the apparatus.

2. Description of Related Art

Along with development of wireless technology, wireless communication apparatuses such as mobile phones, personal digital assistants (PDAs), are widely used in our daily life. The communication apparatuses include displays to display images and words to users. In the display, an image consists of a figure and a background color. While the figure (icons, words, etc.) is useful to indicate status of the apparatus or impart other useful information, the background color does not.

Therefore, an improvement for a wireless communication apparatus and a method are needed in the industry to address the aforementioned deficiency.

### SUMMARY

A wireless communication apparatus includes a communication module, a display, and a color control module. The communication module is for sending a message to a base station, and receiving a switch command from the base station. The display is for displaying an image. The color control module is for being enabled based on the switch command to replace a background color of the image. A method for replacing a background color of the wireless communication apparatus is also disclosed.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram showing a wireless communication apparatus in accordance with an exemplary embodiment;

FIG. 2 is a schematic diagram showing a detailed structure of the wireless communication apparatus of FIG. 1;

FIG. 3 is a schematic diagram showing a human machine interface of the wireless communication apparatus of FIG. 1;

FIG. 4 is a schematic diagram showing a color setting menu corresponding to a color setting icon of FIG. 3;

FIG. 5 is a schematic diagram showing a result interface corresponding to the color setting menu of FIG. 4; and

FIG. 6 is a process flow diagram illustrating a method for replacing a background color in accordance with an exemplary embodiment.

### DETAILED DESCRIPTION OF THE EMBODIMENT

Reference will now be made to the drawings to describe a preferred embodiment of the present wireless communication apparatus and a preferred embodiment of the present method for replacing background color of a display of the wireless communication apparatus.

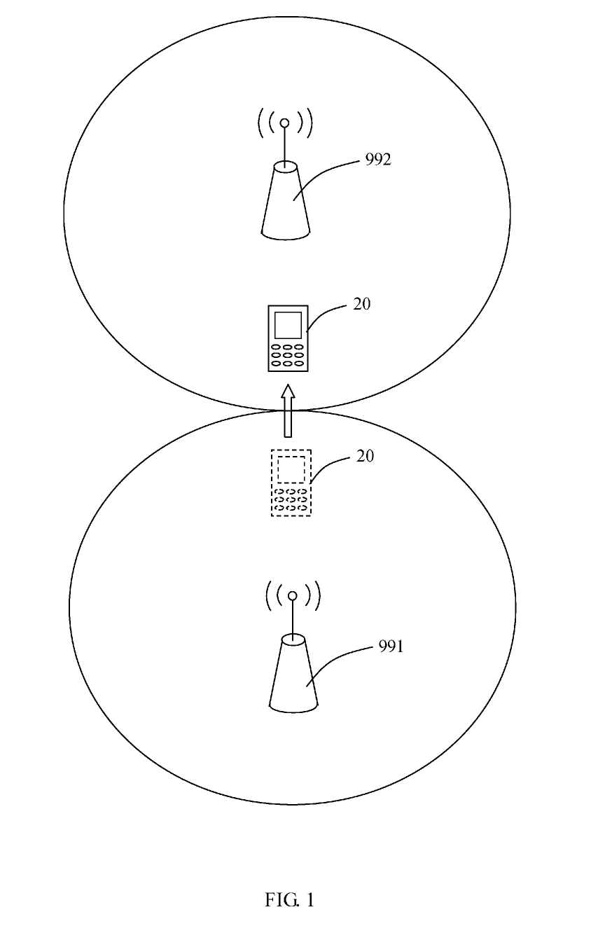

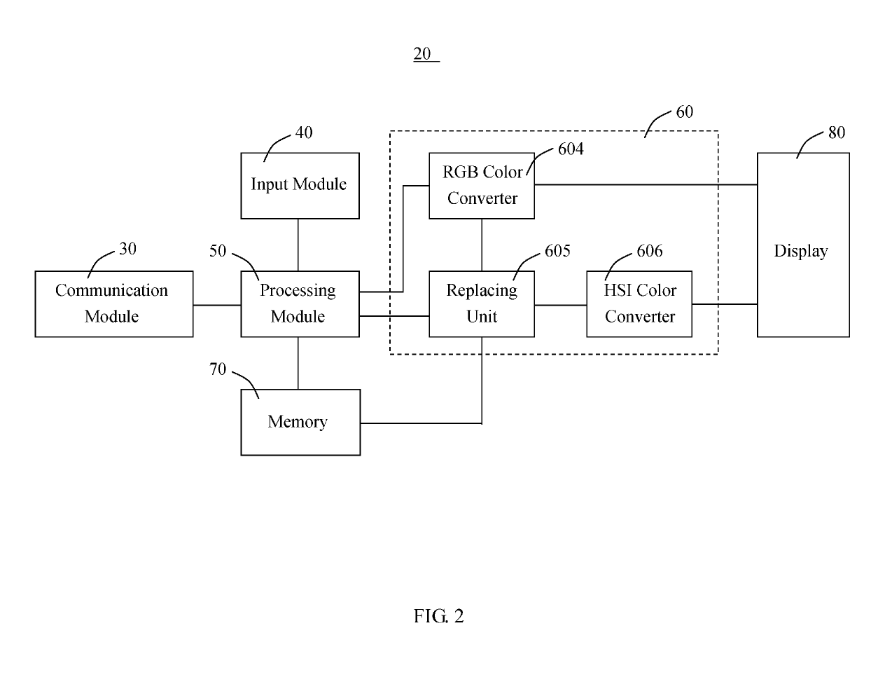

Referring to FIG. 1, a wireless communication apparatus 20 in accordance with an exemplary embodiment can automatically replace its background color of a display 80 (referring to FIG. 2) when the wireless communication apparatus 20 changes base stations. For example, when a location of the wireless communication apparatus 20 changes from being within a first coverage area of a first base station 991 to being within a second coverage area of a second base station 992.

Referring to FIG. 2, the wireless communication apparatus 20 includes a communication module 30, an input module 40, a processing module 50, a color control module 60, a memory 70, and the display 80.

The communication module 30 is for communicating with the base stations 991, 992. In the embodiment, when the wireless communication apparatus 20 changes base stations, the communication module 30 automatically sends a message to the second base station 992, and receives a switch command from the second base station 992. The wireless communication apparatus 20 switches to a new channel according to the switch command.

The input module 40 is for allowing users to configure the wireless communication apparatus 20, such as to set deletable preset values including a hue value of a HSI (Hue, Saturation, Intensity) data. The processing module 50 is for receiving the switch command from the communication module 30 and for enabling the color control module 60 based on the switch command, and storing the preset values into the memory 70. The color control module 60 is for reading a preset hue value stored in the memory 70, and reading current RGB (Red, Green, Blue) data of an image from the display 80 and replacing the current RGB data with the preset hue value to obtain new RGB data.

The color control module 60 includes an RGB color converter 604, a replacing unit 605, and an HSI color converter 606.

The RGB color converter 604 is for reading the current RGB data and converting the RGB data to current HSI data according to the following formulas:

$$\begin{matrix}F = \frac{2 R - G - B}{G - B} & ( 1 ) \\ I = \frac{R + G + B}{3} & ( 2 ) \\ H = \frac{1}{360} [ 90 - arctan ( F / \sqrt{3} ) + \{ 0 , G > B ; 180 , G < B \} ] & ( 3 ) \\ S = 1 - [ \frac{min ( R , G , B )}{I} ] & ( 4 )\end{matrix}$$

wherein R indicates red value, G indicates green value, B indicates blue value, H indicates hue value, S indicates saturation value, I indicates intensity value, and F indicates a value of the RGB data.

The replacing unit 605 is for reading the preset hue value, and replacing a hue value of the current HSI data with the preset hue value to generate a new HSI data. The HSI color converter 606 is for converting the new HSI data to the new RGB data according to the aforementioned formulas. The display 80 is for displaying the image with the new RGB data.

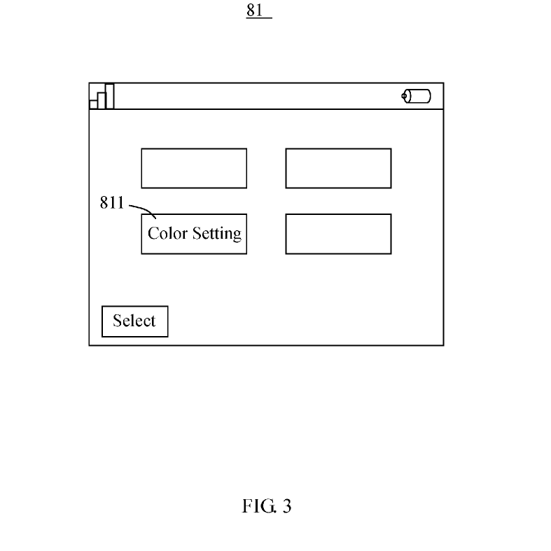

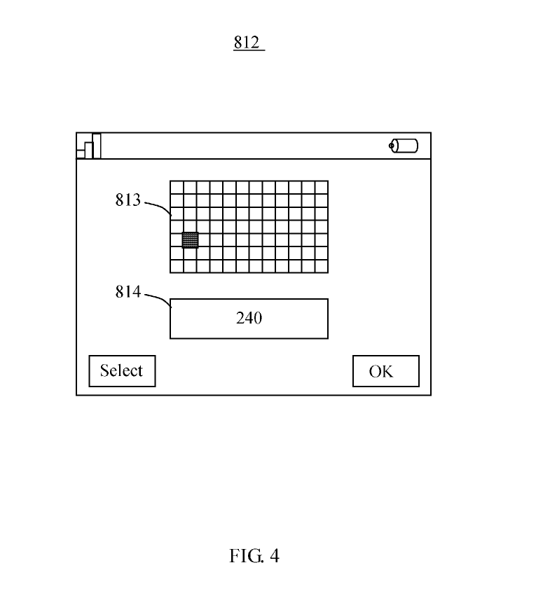

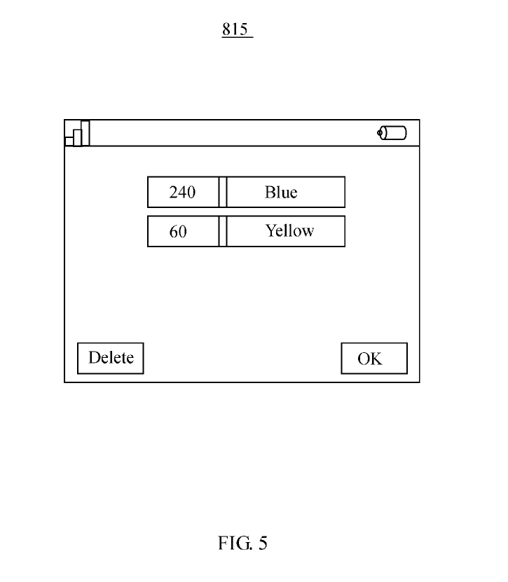

Referring to FIGS. 3, 4, and 5, a human machine interface 81 of the display 80 includes many icons such as a color setting icon 811. If the color setting icon 811 is clicked by users via the input module 40, a color setting menu 812 is displayed. The color setting menu 812 includes a color palette 813 and a number column 814. The color palette 813 includes a set of selectable colors. The number column 814 is for displaying a number corresponding to a selected color. The number is a hue value. For example, when a blue color is selected, a number “240” is displayed in the number column 814. After the color is selected, an OK button is pushed, and a result interface 815 is displayed. The result interface 815 includes a set of selected colors and corresponding numbers. The colors and corresponding numbers are stored into the memory 70 using the store button, and each color and a corresponding number can be deleted using the delete button.

As mentioned above, the wireless communication apparatus 20 can automatically replace its background color of the display 80 when the wireless communication apparatus 20 changes base stations.

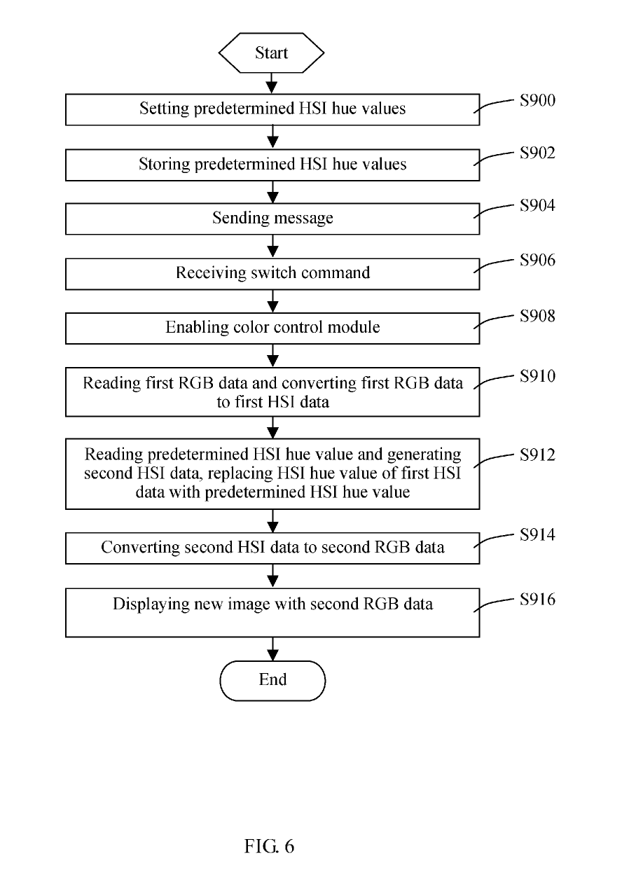

Referring to FIG. 6, a method in accordance with an exemplary embodiment is for replacing a background color of the display of the wireless communication apparatus 20. A procedure of the method includes the following steps.

Preset hue values are set via the input module 40 (step S900).

The preset hue values are stored into the memory 70 (step S902).

The communication module 30 sends the message to the second base station 992 when a location of the 20 changes from being within a first coverage area of a first base station 991 to being within a second coverage area of a second base station 992. (step S904).

The communication module 30 receives the switch command (step S906).

The processing module 50 enables the color control module 60 based on the switch command (step S908).

The RGB color converter 604 reads the current RGB data of the image, and converts the RGB data to the current HSI data (step S910).

The replacing unit 605 reads the preset hue value, and replaces the hue value of the current HSI data with the preset hue value to generate the new HSI data (step S912).

The HSI color converter 606 converts the new HSI data to the new RGB data (step S914).

The display 80 displays the image with the new RGB data (step S916).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless communication apparatus comprising:
a communication module for sending a message to a base station and receiving a switch command from the base station;
a display for displaying an image; and
a color control module replacing a background color of the image based on the switch command.

2. The wireless communication apparatus according to claim 1, wherein the color control module comprises a Red, Green, Blue (RGB) color converter for reading current RGB data of the image, and converting the RGB data to current Hue, Saturation, Intensity (HSI) data.

3. The wireless communication apparatus according to claim 2, wherein the color control module comprises a replacing unit for replacing a hue value of the current HSI data with a preset hue value to generate a new HSI data.

4. The wireless communication apparatus according to claim 3, wherein the color control module comprises an HSI color converter for converting the new HSI data to a new RGB data.

5. The wireless communication apparatus according to claim 1, further comprising a memory for storing preset values.

6. The wireless communication apparatus according to claim 5, further comprising an input for inputting the preset values.

7. The wireless communication apparatus according to claim 6, further comprising a processing module for storing the preset values into the memory.

8. The wireless communication apparatus according to claim 1, further comprising a processing module for enabling the color control module based on the switch command.

9. A method for replacing a background color of a display of a wireless communication apparatus comprising:
sending a message to a base station;
receiving a switch command from the base station;
enabling a color control module based on the switch command;
replacing a background color of an image.

10. The method according to claim 9, further comprising:
reading current RGB data of the image;
converting the current RGB data to a current HSI data;
reading a preset hue value;
replacing a hue value of the current HSI data with the preset hue value to generate a new HSI data; and
converting the new HSI data to new RGB data.

11. The method according to claim 10, further comprising:
setting the preset hue value;
storing the preset hue value.

12. The method according to claim 10, further comprising:
displaying the image with the new RGB data.
